(19) United States
(12) Patent Application Publication
(10) Pub. No.: US 2017/0344577 A1
(43) Pub. Date: Nov. 30, 2017

(54) BIOLOGICAL INFORMATION MEASURING APPARATUS, COMMUNICATION SYSTEM, AND COMMUNICATION METHOD

(71) Applicant: SEIKO EPSON CORPORATION, Tokyo (JP)

(72) Inventor: Shintaro NAGASAKI, Hara-mura (JP)

(73) Assignee: SEIKO EPSON CORPORATION, Tokyo (JP)

(21) Appl. No.: 15/584,651

(22) Filed: May 2, 2017

(30) Foreign Application Priority Data
May 24, 2016 (JP) 2016-103213

(51) Int. Cl. G06F 17/30; H04L 29/08; G06F 3/06; H04W 4/00; H04W 24/02; H04W 72/04; H04W 88/08

(52) U.S. Cl. CPC G06F 17/30147; H04W 24/02; H04L 67/12; H04W 72/0473; H04W 72/0453; G06F 3/0625; H04W 4/008; H04M 2250/02; H04W 88/085

(57) ABSTRACT

A biological information measuring apparatus includes a sensor unit, a processing unit that detects biological information on the basis of sensor information received from the sensor unit, and a communication unit that transmits the biological information to a connection target device at a transmission speed corresponding to a scheduled transmission data amount of the biological information.

### CROSS-REFERENCES TO RELATED APPLICATIONS

This application claims priority to Japanese Patent Application No. 2016-103213 filed May 24, 2016, the entirety of which is herein incorporated by reference.

### BACKGROUND

### 1. Technical Field

The present invention relates to a biological information measuring apparatus, a communication system, a communication method, and the like.

### 2. Related Art

In recent years, various wireless communication methods and particularly, short-range wireless communication methods have been used. As short-range wireless communication, for example, Bluetooth (registered trademarks the same applies hereinafter) has been widely known. There are various standards of Bluetooth. In particular, Bluetooth low energy (BLE) has an advantage of extremely low power consumption.

In JP-A-2014-110635, a method of managing a BLE device by using attribute information of the BLE device, user information, and the like is disclosed.

The short-range wireless communication is often used by a device, such as a smart phone or a wearable apparatus, which has a comparatively small battery capacity, and it is important to suppress power consumption caused by communication. BLE has a low communication speed (approximately 20 Kbps), but has an advantage of extremely low power consumption.

In many cases of short-range wireless communication such as BLE, a transmission speed can be arbitrarily set. There is an inversely proportional correlation between a transmission speed and power consumption as illustrated in FIG. 1 to be described later. For this reason, an attempt to excessively reduce power consumption results in a decrease in transmission speed, and thus there is a concern that usability is impaired. On the other hand, in a case where a transmission speed excessively higher than a transmission speed that does not impair usability is used, power consumption is increased in spite of a small contribution to usability, and thus efficient communication is not achieved. That is, it necessary to set the transmission speed to an appropriate value taking usability and current consumption into consideration.

In JP-A-2014-110635, the management of the BLE device is disclosed, but the setting of a transmission speed taking power consumption into consideration is not disclosed.

### SUMMARY

An advantage of some aspects of the invention is to provide a biological information measuring apparatus, communication system, a communication method, and the like for performing efficient communication by using a transmission speed corresponding to a scheduled transmission data amount.

An aspect of the invention relates to a biological information measuring apparatus including a sensor unit, a processing unit that detects biological information on the basis of sensor information received from the sensor unit, and a communication unit that transmits the biological information to a connection target device at a transmission speed corresponding to a scheduled transmission data amount of the biological information.

In the aspect of the invention, the biological information detected on the basis of the sensor information is transmitted to the connection target device at the transmission speed corresponding to the scheduled trans mission data amount. Thereby, the transmission speed can be determined in consideration of the scheduled transmission data amount, and thus it is possible to suppress a deterioration in usability and the like due to an excessive increase in power consumption or an increase in a transmission time.

In the aspect of the invention, the communication unit may receive a transmission speed change request, which is information for requesting a change to a predetermined transmission speed, from the connection target device, and the processing unit may perform a process of instructing the communication unit to set the transmission speed based on the transmission speed change request.

With this configuration, it is possible to perform the change of a transmission speed from the biological information measuring apparatus side on the basis of the request received from the connect target device.

In the aspect of the invention, the communication unit may transmit scheduled transmission data amount information indicating the scheduled transmission data amount of the biological information to the connection target device, may receive the transmission speed change request indicating the transmission speed determined on the basis of the scheduled transmission data amount information from the connection target device, and may transmit the biological information to the connection target device at the transmission speed based on the received transmission speed change request,

With this configuration, it is possible to set the transmission speed by transmitting the scheduled transmission data amount and receiving the transmission speed change request from the connection target device.

in the aspect of the invention, the communication unit may transmit the biological information to the connection target device at a first transmission speed in a case where the scheduled transmission data amount of the biological information is a first data amount, and may transmit the biological information to the connection target device at a second transmission speed higher than the first transmission speed in a case where the scheduled transmission data amount of the biological information is a second data amount larger than the first data amount.

With this configuration, it is possible to transmit the biological information at a transmission speed based on the size of the scheduled transmission data amount.

In the aspect of the invention, the processing unit may perform a process of computationally calculating the scheduled transmission data amount or a process of computationally calculating the transmission speed corresponding to the scheduled transmission data amount, on the basis of a determination result for a user's action.

With this configuration, it is possible to perform processing based on the action determination result.

In the aspect of the invention, the biological information measuring apparatus may further include a storage unit that stores log data of the biological information, and the communication unit may transmit a transmission request event for the log data to the connection target device.

With this configuration, it is possible to store the log data and transmit the transmission request event.

In the aspect of the invention, the communication unit may transmit the transmission request event to the connection target device in a case where elapse of a predetermined time or a change in the user action state is detected.

With this configuration, it is possible to transmit the transmission request event in a case where a predetermined condition is satisfied.

In the aspect of the invention, the communication unit may perform short-range wireless communication and sets the transmission speed on the basis of a connection interval indicating an interval between connection events of the short-range wireless communication.

With this configuration, it is possible to set the transmission speed by using the connection interval of the short-range wireless communication.

In the aspect of the invention, the communication unit may set connection slave latency of the short-range wireless communication, and the communication unit may not perform neglect of the connection event based on the connection slave latency when the transmission speed based on the connection interval is set.

With this configuration, it is possible to perform communication using the connection slave latency of the short-range wireless communication.

In the aspect of the invention, the communication unit may transmit the scheduled transmission data amount as a response to a packet during the connection event which is received from the connection target device, in a case where a request for the scheduled transmission data amount is included in the packet.

With this configuration, it is possible to transmit the scheduled transmission data amount to the connection target device as a response to the packet during the connection event.

In the aspect of the invention, the communication unit may be set on a slave side in the short-range wireless communication, and the communication unit may perform setting of the transmission speed on a communication unit of the connection target device.

With this configuration, it is possible to perform the setting of the transmission speed on the connection target device from the biological information measuring apparatus which is the slave side in the short-range wireless communication.

In the aspect of the invention, the communication unit may perform a change to a transmission speed different from a given transmission speed in a case where a setting failure response is returned by the communication unit of the connection target device, with respect to a request for a change to the given transmission speed.

With this configuration, it is possible to perform the resetting of the transmission speed.

In the aspect of the invention, the connection target device may be a portable information processing apparatus or a gateway device.

With this configuration, it is possible to use various devices as the connection target device

Another aspect of the invention relates to a communication system including the biological information measuring apparatus described above and the connection target device.

Still another aspect of the invention relates to a communication method including detecting biological information on the basis of sensor information received from a sensor unit, and transmitting the biological information to a connection target device at a transmission speed corresponding to a scheduled transmission data amount of the biological information.

### BRIEF DESCRIPTION OF THE DRAWINGS

The invention will be described with reference to the accompanying drawings, wherein like numbers reference like elements.

FIG. 1 is a diagram illustrating a relationship between a transmission speed (connection interval) and power consumption.

FIG. 2 illustrates a configuration example of a biological information measuring apparatus.

FIG. 3 is a diagram illustrating the exterior of the biological information measuring apparatus.

FIG. 4 is a diagram illustrating the exterior of the biological information measuring apparatus.

FIG. 5 illustrates examples of a biological information measuring apparatus and a connection target device.

FIG. 6 illustrates a configuration example of a communication system.

FIG. 7 is a flow chart illustrating processing performed by a processing unit of the biological information measuring apparatus.

FIG. 8 is a diagram illustrating a layered configuration of short-range wireless communication.

FIG. 9 is a diagram illustrating a communication sequence between the biological information measuring apparatus and the connection target device.

FIG. 10 is a diagram illustrating an occurrence timing of a transmission request event.

FIG. 11 illustrates an example of a communication sequence in a case where connection slave latency is used.

FIG. 12 is a diagram illustrating a communication sequence between the biological information measuring apparatus and the connection target device.

FIG. 13 is a diagram illustrating a communication sequence between the biological information measuring apparatus and the connection target device.

FIG. 14 illustrates a configuration example of a gateway device which is a connection target device.

FIG. 15 is a diagram illustrating connection between the biological information measuring apparatus and the gateway device.

### DESCRIPTION OF EXEMPLARY EMBODIMENTS

Hereinafter, this embodiment will be described. Meanwhile, this embodiment described below is not unduly limited to the contents of the invention described in the appended claims. In addition, all the configurations described in this embodiment are not limited to being essential components of the invention.

### 1. Method in This Embodiment

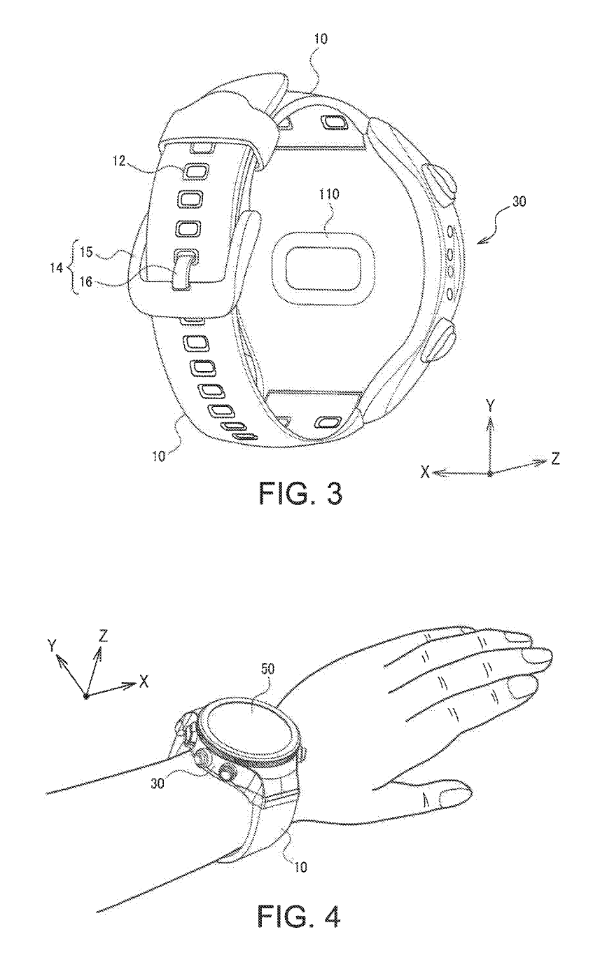

First, a method in this embodiment will be described. In recent years, an apparatus measuring biological information by using various sensors has been used. For example, in a wearable type biological information measuring apparatus to be described later with reference to FIG. 3 or 4, it is possible to detect pulse wave information of a user by using a pulse wave sensor such as a photoelectric sensor or an ultrasonic sensor.

Biological information acquired can also be displayed on a display unit of the biological information measuring apparatus, but may be displayed on a display unit of a smart phone (portable information processing apparatus in a broad sense) which is operated by the user. The size of a display unit of a wearable device is limited, or it is also considered that the wearable device does not include a display unit in some cases. Accordingly, it is possible to present biological information to a user in a high visibility mode by using a display unit of another device.

In addition, the biological information is stored over a long period of time to a certain extent, and it is also possible to obtain a transition of the user's health condition by performing statistical processing. That is, there is a possibility that a huge amount of data regarding the biological information is stored or the biological information becomes a target for processing having a high processing load. In this case, there is an advantage obtained by the transmission of biological information to another device such as a smart phone, a personal computer (PC), or a server system, rather than performing storage and processing by a biological information measuring apparatus having a great restriction on storage capacity or processing performance.

In this manner, in the biological information measuring apparatus, there a strong request for communication (transmission) to another device of biological information. However, it is assumed that the biological information measuring apparatus is restricted in battery capacity like the above-described wearable device, and thus it is not preferable that power consumption caused by communication increases.

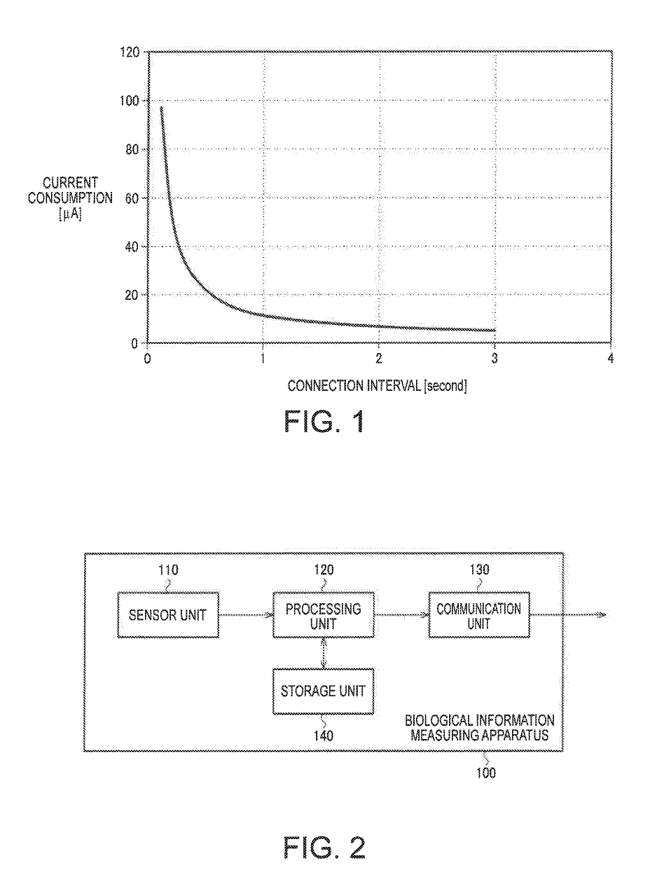

On the other hand, BLE is widely known as a short-range wireless communication method with low power consumption, and various methods using BLE, such as in JP-A-2014-110635, are also known. In the BLE, it is possible to change a transmission speed by changing the value of a connection interval (connInterval which is a connection parameter) to be described later. It is known that there is an inversely proportional correlation between a transmission speed and power consumption as illustrated in FIG. 1. The horizontal axis in FIG. 1 represents the length of a connection interval, and the transmission speed becomes lower as the value of the connection interval becomes larger (becomes closer to the right side). In addition, the vertical axis in FIG. 1 represents current consumption, and represents that power consumption increases as the current consumption becomes closer to the upper side. That is, the BLE originally has low power consumption, but it is also possible to achieve a further reduction in power consumption by decreasing a transmission speed.

However, an appropriate transmission speed varies depending on situations. For example, in a case where a transmission speed is s o be an excessively low transmission speed in consideration of a reduction in power consumption, time required for the completion of data transmission (transmission time) is increased. For example, in a case where a condition that a time between the execution of a user' s any operation and the actual display of biological information is within a predetermined time is satisfied, it is known that the user does not feel stressed very much, that is, a certain degree of usability is secured. The condition is generally satisfied by setting the transmission time to 3 seconds or less. For this reason, when the transmission time exceeds 3 seconds due to the transmission speed being set to be excessively low, usability deteriorates, which leads to an undesirable result.

On the other hand, there is no problem when the transmission time falls within approximately 3 seconds, and an effect of improving usability it not very expectable even when the transmission time is reduced to, for example, 1 second. That is, even when the transmission time is excessively reduced by increasing the transmission speed, a small contribution is made to usability, and besides, there is a disadvantage of an increase in power consumption.

As described above, it is necessary to set a transmission speed in communication in consideration of power consumption and usability. JP-A-2014-110635 discloses a method of managing a BLE device, but does not disclose a reduction in power consumption or the setting of a transmission speed.

In addition, in the setting of a transmission speed, a method of associating the start-up of an application and a transmission speed with each other is also considered. Here, the application means, for example, application software that operates on an operating system (OS) of a portable information processing apparatus. The application realizes a function of receiving biological information and a function of displaying the biological information, and a situation in which the application is started up is a situation in which a user's viewing of biological information is assumed. For this reason, it seems that it is possible to prevent usability from being impaired by increasing a transmission speed (by operation in a high-speed transmission mode) during the start-up of the application and to reduce power consumption by decreasing the transmission speed (operation in a low-speed transmission mode) during other periods of time.

However, in the method of associating the start-up of an application and a transmission speed with each other, the actual scheduled transmission data amount is not considered. For example, it is also possible to consider a case where the amount of data required to be transmitted even during the start-up of an application is small. In this case, since it is possible to realize sufficient usability even when a transmission speed is decreased to a certain extent, an operation in a high-speed transmission mode causes undesirable performance in a case of being considered to be anti-power consumption. That is, it is difficult to set an optimal transmission speed by only associating the start-up of an application and a transmission speed with each other.

Therefore, this applicant proposes a method of setting a transmission speed corresponding to a scheduled transmission data amount. As illustrated in FIG. 2, biological information measuring apparatus 100 according to this embodiment includes a sensor unit 110, a processing unit 120 that detects biological information on the basis of sensor information received from the sensor unit 110, and a communication unit 130 that transmits the biological information to a connection target device 200 at a transmission speed corresponding to a scheduled transmission data amount of the biological information.

Here, the sensor unit 110 is a biological sensor for detecting biological information in a narrow sense, and includes a pulse wave sensor and the like . However, the sensor unit 110 may include a body motion sensor that detects a user' s body motion or an environmental sensor that detects information regarding the peripheral environment of the user. A specific example of the sensor unit 110 will be described later.

In addition, the biological information means information indicating the state of a user's biological activity. The biological information in this embodiment is, for example, pulse wave information, and may be specifically information such as a pulse rate or a pulse interval. However, the biological information is not limited to pulse wave information, and may be another information, such as information of arterial oxygen saturation or information of body temperature, which indicates a user's biological activity.

In addition, the connection target device 200 means a device to be connected to the biological information measuring apparatus 100, and is a device to which biological information is transmitted. The connection target device 200 is a portable information processing apparatus 400 such as a smart phone used by a user. However, the connection target device 200 may be another device such as a gateway device 600 (router) as described later as a modification example.

In the method of this embodiment, a transmission speed can be set to be a speed corresponding to a scheduled transmission data amount. For this reason, in a case where the scheduled transmission data amount is small, power consumption can be reduced by setting the transmission speed to be low, and thus it is possible to achieve efficient communication. In addition, in a case where the scheduled transmission data amount is large, the transmission speed can be set to be high, and thus it is possible to suppress deterioration of usability.

That is, specifically, the communication unit 130 transmits the biological information to the connection target device 200 at a first transmission speed in a case where the scheduled transmission data amount of the biological information is a first data amount, and transmits the biologic information to the connection target device 200 at a second transmission speed higher than the first transmission speed in a case where the scheduled transmission data amount of the biological information is a second data amount greater than the first data amount.

In this manner, a necessary transmission speed can be set from the scheduled transmission data amount, and thus it is possible to suppress an increase in power consumption, and the like by setting an excessively high transmission speed.

Hereinafter, a detailed processing sequence (communication sequence) in this embodiment will be described after a description of a detailed example of the biological information measuring apparatus 100. Finally, some modification examples will be described.

### 2. System Configuration Example

A system configuration example of the biological information measuring apparatus 100 is as illustrated in FIG. 2. The biological information measuring apparatus 100 includes the sensor unit 110, the processing unit 120, the communication unit 130, and a storage unit 140. Here, the biological information measuring apparatus 100 is not limited to having a configuration illustrated in FIG. 2, and various modifications such as the omission of a portion of these components or the addition of other components can be made.

The sensor unit 110 includes a biological sensor for measuring biological information. For example, the sensor unit 110 may include a pulse wave sensor for measuring pulse wave information. A pulse wave is shown as a change in the volume of blood, and thus the pulse wave sensor measures the pulse wave by capturing a change in the amount of blood of a region to be measured. Considering that there is a correlation between a blood flow rate and the amount of hemoglobin in blood, the amount of light absorbed is large and the intensity of transmitted light or reflected light is decreased when a blood flow rate is high and the amount of hemoglobin is large in a case where a blood vessel is irradiated with light. In contrast, when a blood flow rate is low and the amount of hemoglobin is small, the amount of light absorbed is small and the intensity of transmitted light or reflected light is increased. That is, the pulse wave sensor is a photoelectric sensor including a light emitting unit and a light receiving unit, and it is possible to detect pulse wave information on the basis of temporal changes in a detected signal in the photoelectric sensor.

Meanwhile, light emitted by the light emitting unit of the pulse wave sensor may have a wavelength easily absorbed by hemoglobin, and green light is generally used. In addition, the pulse wave information is not limited to a pulse rate, and may be a pulse interval (RR interval), may be a fluctuation in a pulse interval, or may be another information indicating a pulse wave. In addition, the pulse wave information may be a pulse wave analysis index, such as an activity state, stressed state, or relaxed state of an autonomic nerve, which is derived on the basis of a fluctuation in a pulse interval.

In addition, the sensor unit 110 may include a sensor that measures biological information other than the pulse wave information. For example, the sensor unit 110 may include a sensor that measures arterial oxygen saturation (SpO2). In addition, the sensor unit 110 may include a body motion sensor that detects a user's body motion. Here, the body motion sensor can be realized by an acceleration sensor, a gyro sensor, a global positioning system (GPS) receiver, a azimuth sensor, or the like.

The processing unit 120 performs various processes including a process of generating biological information on the basis of sensor information received from the sensor unit 110. The function of the processing unit 120 can be realized by a processor. Here, the processor may be, for example, a central processing unit (CPU). However, the processor is not limited to the CPU, and various processors such as a graphics processing unit (GPU) and a digital signal processor (DSP) can be used. In addition, the processor may be a hardware circuit based on an application specific integrated circuit (ASIC).

For example, the processing unit 120 performs frequency conversion processing on the sensor information received from the pulse wave sensor to thereby perform a process of obtaining a pulse rate or a pulse interval. Since a peak frequency is considered to be the frequency of a pulse, a value obtained by multiplying the frequency by 60 times is set to be a pulse rate which is widely used, and the reciprocal of the peak frequency is equivalent to a pulse interval (RRI). However, there are known various other methods of obtaining biological information from sensor information, and these methods can be widely applied in this embodiment.

The communication unit 130 transmits and receives information to and from the connection target device 200. For example, the communication unit 130 is a circuit (IC) that performs short-range wireless communication using an antenna. The communication unit 130 can be realized by hardware, such as a communication ASIC or a communication processor, firmware for communication, or the like. Specifically, the communication unit 130 includes a logic circuit for realizing, for example, a physical layer circuit, a link layer circuit, and the like. The physical layer circuit includes a reception circuit and a transmission circuit. The reception circuit includes a low noise amplifier amplifying a signal received from the antenna with low noise, a mixer, a filter, and the like. The transmission circuit includes a power amplifier that outputs a transmission signal to the antenna. The logic circuit may include a demodulation circuit, a modulation circuit, a reception buffer, a transmission buffer, processing circuit, an interface circuit, and the like. For example, the communication unit 130 transmits biological information generated by the processing unit 120 to the connection target device 200. A specific communication sequence will be described later with reference to FIG. 9 and the like. Meanwhile, short-range wireless communication in this embodiment is not limited to Bluetooth (BLE in a narrow sense), and ZigBee (registered trademark), Wi-SUN (registered trademark), IP500 (registered trademark), and the like may be used.

The storage unit 140 serves as a work area of the processing unit 120 and the like, and the function thereof can be realized by a semiconductor memory such as a random access memory (RAM) or can be realized by a register, a hard disk drive (HDD), or the like. The storage unit 140 stores biological information obtained by the processing unit 120. The storage unit 140 (memory) stores a command readable by a computer, and each unit of the information measuring apparatus 100 according to this embodiment may be realized by the command being realized by a processor. Here, the command may be a command of a command set constituting a program, or may be a command for instructing a hardware circuit of the processor on operation.

The biological information measuring apparatus 100 according to this embodiment can be realized as a wearable device worn on a user's body. FIG. 3 is a diagram illustrating an example of the exterior of a wearable device. As illustrated in FIG. 3, the wearable device includes a case portion 30 and a band portion 10 for fixing the case portion 30 to a user's body (wrist in a narrow sense), and the band portion 10 is provided with fitting holes 12 and a buckle 14. The buckle 14 includes a buckle frame 15 and a locking portion (projection rod) 16.

FIG. 3 is a perspective view when the wearable device having the band portion 10 being fixed using the fitting hole 12 and the locking portion 16 is seen from a direction on the band portion 10 side (surface side which is a test subject side in the surface of the case portion 30 in a wearing state). In the wearable device of FIG. 3, the band portion 10 is provided with the plurality of fitting holes 12, and the locking portion 16 of the buckle 14 is inserted into any one of the plurality of fitting holes 12, thereby wearing the wearable device on the user. The plurality of fitting holes 12 are provided along the longitudinal direction of the band portion 10 as illustrated in FIG. 3.

The case portion 30 of the wearable device is provided with the sensor unit 110. In FIG. 3, a pulse wave sensor (specifically, a photoelectric sensor) is assumed, and an example is illustrated in which the sensor unit 110 is provided on a surface which is a test subject side in the case portion 30 during the wearing of the wearable device. However, the position of a sensor included in the sensor unit 110 is not limited to that illustrated in FIG. 3. For example, the sensor included in the sensor unit 110 may be provided inside the case portion 30 (particularly, on a sensor substrate included in the case portion 30).

FIG. 4 is a diagram when the wearable device worn on the user is seen from a side on which a display unit 50 is provided. As seen from FIG. 4, a wearable device 300 according to this embodiment includes the display unit 50 at a position equivalent to the dial of an ordinary wrist watch or a position where numbers or icons are visible. In a wearing state of the wearable device, a surface on the side illustrated in FIG. 3 in the case portion 30 is adhered to a test subject, and the display unit 50 is positioned so as to facilitate the user's visual recognition. However, the wearable device may be configured so as not to include the display unit 50.

Meanwhile, in FIGS. 3 and 4, a coordinate system is set based on the case portion 30 of the wearable device, and a direction, intersecting the display surface of the display unit 50, which is a direction toward the front surface from the rear surface in a case of setting the display surface side of the display unit 50 to be the front surface is set to be a Z-axis positive direction. Alternatively, a direction toward the display unit 50 from the sensor unit 110 (photoelectric sensor illustrated in FIG. 3 in a narrow sense) or a direction receding from the case portion 30 in the normal direction of the display surface of the display unit 50 may be defined as the Z-axis positive direction. In a state where the wearable device is worn on the test subject, the Z-axis positive direction is equivalent to a direction toward the case portion 30 from the test subject. In addition, two axes perpendicular to the Z-axis are set to be X and Y axes, respectively, and particularly, a direction in which the band portion 10 is attached to the case portion 30 is set to be the Y-axis.

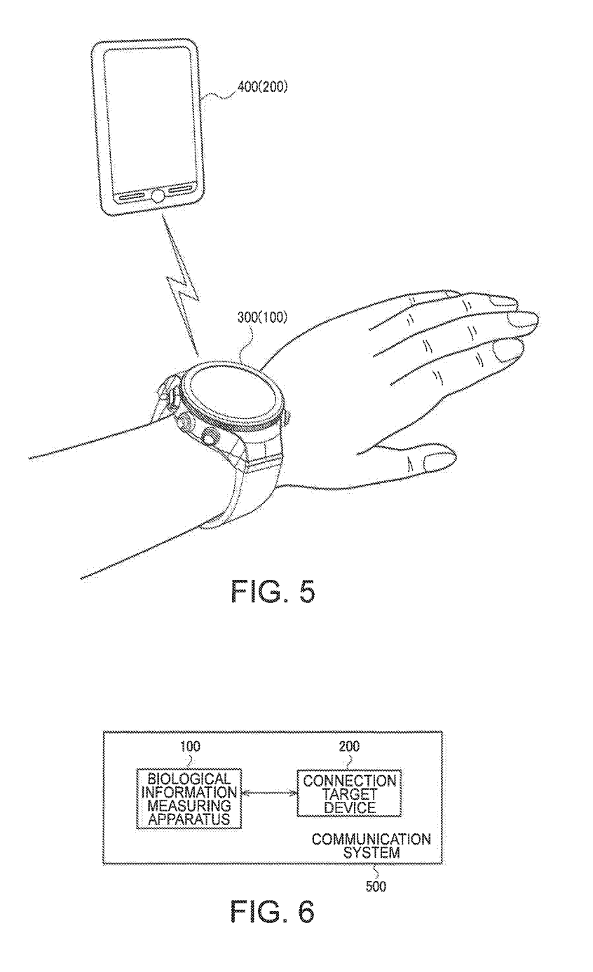

As described above, in this embodiment, the communication unit 130 of the biological information measuring apparatus 100 transmits biological information to the connection target device 200. FIG. 5 illustrates an example of connection between the biological information measuring apparatus 100 (wearable device 300) and connection target device 200. FIG. 5 illustrates an example in which the connection target device 200 is the portable information processing apparatus 400 (more specifically, a smart phone). The wearable device 300 and the portable information processing apparatus 400 are connected to each other by short-range wireless communication. Specifically, the connection target device 200 (portable information processing apparatus 400) includes the same communication unit as the communication unit 130, and the communication unit 130 of the biological information measuring apparatus 100 and the communication unit of the connection target device 200 transmit and receive information to and from each other.

In addition, the method of this embodiment is not limited to being applied to the biological information measuring apparatus 100. For example, the method of this embodiment can be applied to a communication system 500 including the biological information measuring apparatus 100 and the connection target device 200, as illustrated in FIG. 6.

It is possible to reduce power consumption not only in the biological information measuring apparatus 100 but also in the connection target device 200 by performing communication at an appropriate transmission speed. In addition, as described later with reference to FIG. 9, it is assumed that the biological information measuring apparatus 100 and the connection target device 200 can transmit and receive information to and from each other in setting a transmission speed. In this respect, in the communication system 500 having the method of this embodiment applied thereto, it is possible to appropriately perform communication between devices by controlling both the biological information measuring apparatus 100 and the connection target device 200. The communication system 500 according to this embodiment can be realized by the wearable device 300 and the portable information processing apparatus 400, for example, as illustrated in FIG. 5.

In addition, the method of this embodiment can also be applied to a communication method including a process of detecting biological information on the basis of sensor information received from the sensor unit 110, and a communication process of transmitting the biological information to the connection target device 200 at a transmission speed corresponding to a scheduled transmission data amount of the biological information.

### 3. Processing Sequence

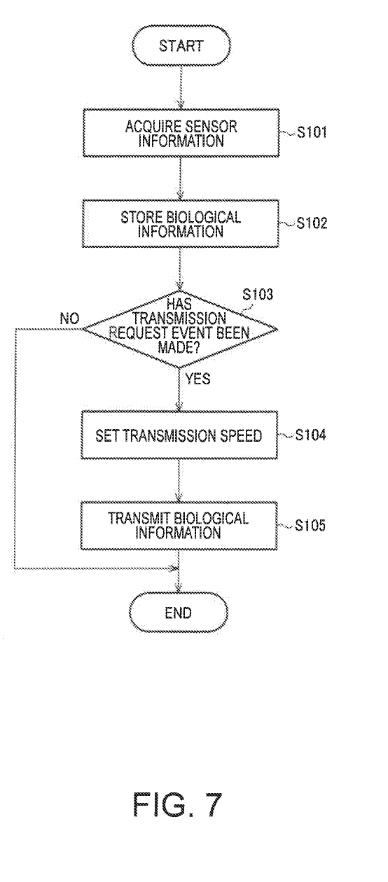

Next, details of a processing sequence (communication sequence) of this embodiment will be described. First, outlines of a flow of processing performed by the processing unit 120 and a flow of communication between the biological information measuring apparatus 100 and the connection target device 200 will be described with reference to FIGS. 7 to 9. Thereafter, steps of FIG. 9 will be described in detail.

### 3.1 Outline

FIG. 7 is a flow chart illustrating processing performed by the processing unit 120 of the biological information measuring apparatus 100. When this processing is started, the processing unit 120 acquires sensor information received from the sensor unit 110 (S101) The processing unit 120 stores biological information based on the sensor information acquired in S101 in the storage unit 140 (S102). Meanwhile, as described above, it is assumed that the processing unit 120 obtains the biological information by performing a computational process based on the sensor information, but it is not also possible to prevent the sensor information itself from being set to be biological information.

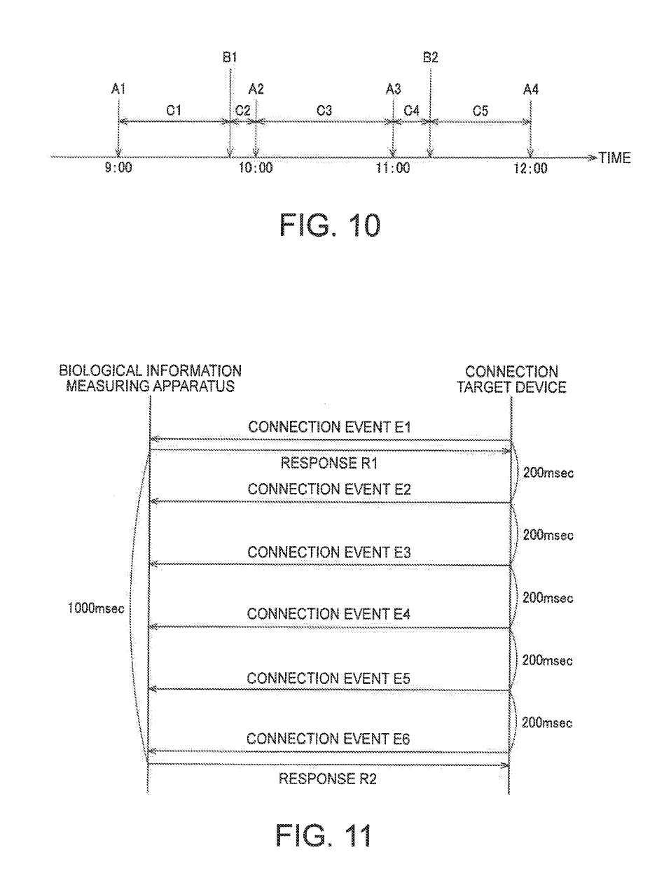

The processing unit 120 determines whether or not the present timing is a timing when a transmission request event occurs. The transmission request event is an event in which the connection target device 200 is notified of the transmission of a set of pieces of biological information (log data of biological information). As described later with reference to FIG. 10, the amount of log data changes depending on situations, and is the amount of data of, for example, approximately several hundreds to several thousands of bytes. The processing unit 120 determines whether or not log data of biological information is formed in S103.

Since a case where the determination result in S103 is Yes is equivalent to a case where the log data of the biological information is formed, the processing unit 120 performs a process of setting a transmission speed (S104) and transmits the biological information to the connection target device 200 at the set transmission speed (S105). Since a case where the determination result in step S103 is No is equivalent to a case where log data of biological information to be transmitted is not formed, the processes of S104 and S105 are omitted. The processing unit 120 repeatedly performs the processing illustrated in FIG. 7 as long as operation conditions are satisfied.

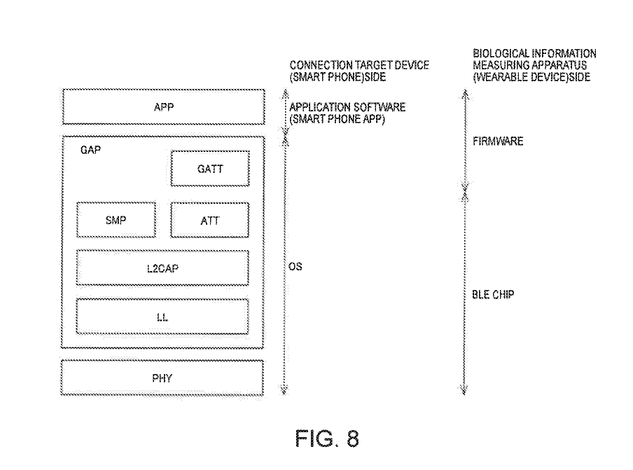

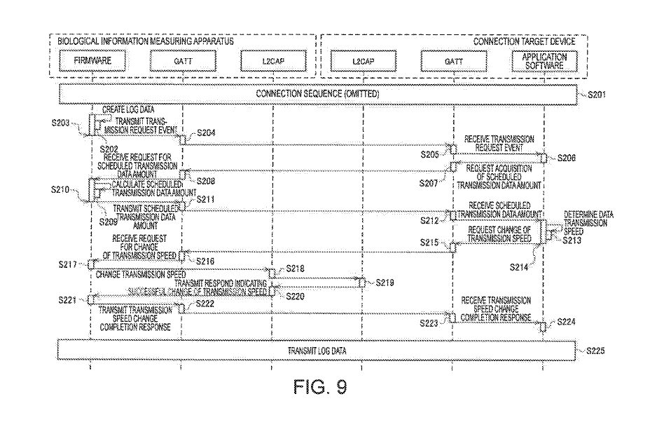

FIG. 7 is a diagram illustrating a flow of processing performed by the processing unit 120 (processor and firmware operating on the processor) of the biological information measuring apparatus 100, and a lower layer (layer corresponding to the communication unit 130) also contributes to the setting of a transmission speed or the transmission and reception of information. Accordingly, layered configurations of the biological information measuring apparatus 100 and the connection target device 200 will be described with reference to FIGS. 8 and 9, and a processing sequence (communication sequence) performed in each layer will be described.

FIG. 8 is a diagram illustrating an example of correspondence between a layered configuration in a case where BLE is taken as an example, the biological information measuring apparatus 100, and the connection target device 200. As illustrated in FIG. 8, the layered configuration of the BLE includes an application (App), a generic access profile (GAP), and a physical layer (PHY). GAP includes a generic attribute profile (GATT), an attribute protocol (ATT), a secure management protocol (SMP), a logical link control and adaptation protocol (L2CAP), and a link layer (LL).

In the biological information measuring apparatus 100, firmware for realizing the processing unit 120 is equivalent to a portion of App and GAP, and a BLE chip for realizing the communication unit 130 is equivalent to the remaining portion of GAP and PHY.

In addition, in the connection target device 200, the OS of the device corresponds to GAP and PHY. In a case where the connection target device 200 is the portable information processing apparatus 400 (particularly, a smart phone), an OS such as Android (registered trademark) which is widely known corresponds to GAP and PHY. In addition, application software (so-called “smart phone application”) operating on the OS corresponds to App.

FIG. 9 is a sequence diagram illustrating processing in each of the layers of the firmware, GATT, and L2CAP of the biological information measuring apparatus 100 and the application software, GATT, and L2CAP of the connection target device 200.

In the BLE, a packet for confirming connection is transmitted from a device on a master side (here, the connection target device 200) to a device on a slave side (biological information measuring apparatus 100) for each time equivalent to a connection interval, and a response packet is returned from the device on the slave side, thereby maintaining the connection. A payload portion in a given layer in the packet for confirming connection includes data indicating a connection event, and the device on the slave side responds to the connection event to thereby maintain the connection. In FIG. 9, a description is given on the assumption that connection between devices is established and the connection is maintained by the confirmation of connection in S201.

Meanwhile, in a normal state corresponding to S201, that is, a state where the transmission of log data of biological information, and the like are not performed because the connection being just maintained is enough, communication at a high frequency is not necessary. Accordingly, the connection interval may be a comparatively large value such as 1000 msec. In addition, with regard to S202 and the subsequent steps, communication is performed by a connection interval in a normal state until the termination of steps S218 and S219 in which a connection interval is updated to a value for the transmission of log data.

As illustrated in FIG. 9, steps performed until the transmission of log data of biological information (S225) are roughly classified into the transmission of a transmission request event from the biological information measuring apparatus 100 (S202 to S205), communication regarding a scheduled transmission data amount (S206 to S212), and communication regarding the setting of a transmission speed based on the scheduled transmission data amount (S213 to S224).

That is, in a case where the sequence of FIG. 9 is captured from the biological information measuring apparatus 100, the communication unit 130 transmits scheduled transmission data amount information indicating a scheduled transmission data amount of biological information to a connection target device (S204), receives a transmission speed change request indicating a transmission speed determined on the basis of the scheduled transmission data amount information from the connection target device 200 (step S208), and transmits the biological information to the connection target device 200 at a transmission speed based on the received transmission speed change request (the actual transmission is performed in step S225, and the setting therefor is performed in S216, S218, and S220).

An appropriate transmission speed is determined on the basis of the scheduled transmission data amount and a transmission time (for example, 3 seconds for preventing usability from being impaired) which may be required for the transmission of the data. The scheduled transmission data amount is information which is ascertained by a device that actually stores log data of biological information, that is, by the biological information measuring apparatus 100. Accordingly, it is possible to perform the determination of a transmission speed (step S213) by the connection target device 200 by transmitting the scheduled transmission data amount to the connection target device 200. It is assumed that the connection target device 200 has processing capability higher than that of the biological information measuring apparatus 100, and thus it is possible to perform the determination of the transmission speed at a higher speed, and the like.

### 3.2 Transmission Request Event

As illustrated in FIG. 9, the firmware (processing unit 120) of the biological information measuring apparatus 100 creates log data of biological information on the basis of sensor information (S202), and transmits a transmission request event (S203). Specifically, the firmware of the biological information measuring apparatus 100 instructs GATT to transmit the transmission request event, and GATT of the biological information measuring apparatus 100 transmits the transmission request event to GATT of the connection target device 200 (S204). Strictly speaking, this communication is also involved with a lower layer, but is omitted in FIG. 9 in order to simplify a description.

GATT of the connection target device 200 receives the transmission request event, and gives notice to application software of the connection target device 200 (S205). The application software receives the transmission request event to start to request the acquisition of the scheduled transmission data amount (S206).

That is, the biological information measuring apparatus 100 includes the storage unit 140 that stores the log data of the biological information, and the communication unit 130 transmits a transmission request event for the log data to the connection target device 200. Here, the transmission request event is an event indicating that the log data of the biological information to be transmitted is stored as described above.

In this manner, an event can occur at a timing when a set (log data) of biological information to be transmitted is generated, and thus the communication unit 130 can appropriately transmit the log data to the connection target device 200. In particular, as illustrated in FIG. 9, the transmission request event serves as a trigger for setting a transmission speed, and thus it is possible to transmit stored log data to the connection target device 200 by using an appropriate transmission speed.

Here, it is possible to consider various methods for a condition in which the transmission request event occurs, that is, a condition for determining that a set of biological information to be transmitted is generated.

The communication unit 130 transmits the transmission request event to the connection target device 200 in a case where the elapse of a predetermined time is detected. That is, the elapse of the predetermined time from the occurrence of the previous transmission request event (and the transmission of log data to the connection target device 200) is set to be a condition in which the transmission request event occurs. In a case where a biological information acquisition rate and the amount of data of biological information acquired at each timing are fixed, the amount of data of the stored biological information (log data) is proportional to measurement time. In addition, even when the rate and the amount of data of biological information at each timing are variable, there is a tendency for the amount of log data to increase as a measurement time generally increases.

Accordingly, since it is considered that a certain degree of amount of data is stored in a case where the predetermined time elapses, the transmission request event may occur. As an example, the transmission request event may occur at a frequency of once for an hour, and specifically, the transmission request event occurs at 0:00, 1:00, . . . , and 23:00. In this manner, the transmission request event occurs at fixed time every day during the measurement of biological information, and thus log data can be transmitted. For this reason, it is possible to easily realize statistical processing in which biological information on a given date and biological information on another date are compared with each other by making times of the dates uniform. In a broader sense, it is possible to facilitate the management or use of the transmitted log data.

In addition, the communication unit 130 may transmit the transmission request event to the connection target device 200 in a case where a change in a user's action state is detected. A user wearing the biological information measuring apparatus 100 does not act in the same manner at all times, and may be set to be in various action states such as a sleep state, a rest state where the user is awake but acts comparatively a little, and a motion state (workout state) where the user is in motion.

Ina case where a pulse rate is acquired as biological information, generally, the value of the pulse rate becomes larger as the user's activity becomes active, and thus the relation of sleep state<rest state<motion state is established. For this reason, it is not appropriate to equally treat data in the sleep state and data in the motion state in analyzing log data of biological information. For example, in the analysis of the log data, a process of changing contents of analysis processing in accordance with the user's action state or a process of performing a change regarding whether to set log data to be a target for the analysis processing in accordance with the action state may be performed. In a case where the transmission request event is generated once an hour, there is a concern that both the data in the sleep state and the data in the motion are included in log data corresponding to an amount for given one hour, thereby making interference with the analysis processing.

In addition, it is known that the user's body motion is small in the sleep state, and there is a small fluctuation in the pulse rate. Accordingly, in the sleep state, resolution may be lowered by decreasing the frequency of acquisition (frequency of computational calculation) of the pulse rate or decreasing the number of bits allocated to one piece of data, as compared to the rest state or the motion state. That is, a difference in the user's action state may result in not only a change in characteristics of biological information but also a possibility that the number of pieces of biological information acquired per unit time or the amount of data per biological information fluctuates. From this aspect, it is not preferable to integrate pieces of biological information differ in an action state into one piece of log data.

Meanwhile, various methods of performing an action determination process are considered, but a body motion sensor detecting a body motion may be used. Specifically, the sensor unit 110 of the biological information measuring apparatus 100 includes a body motion sensor, and the processing unit 120 performs an action determination process on the basis of body motion information received from the body motion sensor to thereby generate a transmission request event on the basis of a result of the action determination process.

Here, the body motion sensor means a sensor that detects the movement of a user (person wearing the biological information measuring apparatus 100), and examples of the body motion sensor to be considered include an acceleration sensor, a gyro sensor, an atmospheric pressure sensor, and the like. The body motion sensor according to this embodiment may be constituted by only a type of sensor, or may be realized by a combination of a plurality of types of sensors. Various methods of determining a user's action are known, and can be widely applied in this embodiment.

FIG. 10 is a diagram illustrating an example of an occurrence timing of a transmission request event. The horizontal axis in FIG. 10 represents a time. FIG. 10 illustrates an example in which a user's state is determined to be a motion state in a period of time between 9:50 (B1) and 11:15 (B2) and is determined to be a reset state before 9:50 and after 11:15 by the determination of the user's action state.

In the example of FIG. 10, first, a transmission request event is periodically generated once an hour at 9:00 (A1), Log data stored for one hour of 8:00 to 9:00 is transmitted at the timing of A1.

At 9:50 (B1), the processing unit 120 determines that the action state has been changed from a rest state to a motion state. When the next transmission request event is performed at 10:00 (A2) as scheduled, log data to be transmitted at A2 corresponds to an amount for one hour of 9:00 to 10:00, and thus data in the rest state and data in the motion state mix with each other. Accordingly, the processing unit 120 (firmware) instructs the generation of a transmission request event at the timing of B1, and the communication unit 130 (GATT) transmits the transmission request event to the communication unit (GATT) of the connection target device 200. Since log data to be transmitted at the timing of B1 is data between 9:00 and 9:50 (range of C1), it is possible to suppress the mixing of data in the motion state.

In the example of FIG. 10, the transmission request event is periodically transmitted at 10:00 (A2). In this case, log data to be transmitted at A2 is data between 9:50 and 10:00 (range of C2). Although the amount of log data to be transmitted at A2 is comparatively small, there is an advantage in generating the transmission request event even at A2 from a viewpoint of facilitating the above-described analysis processing. Particularly, in this embodiment, since a transmission speed is set in accordance with a scheduled transmission data amount, a small amount of log data is not transmitted at an excessively high speed, and thus the small amount of log data hardly becomes disadvantageous.

The same applies hereinafter, and the processing unit 120 periodically generates a transmission request event at 11:00 (A3) and transmits data between 10:00 and 11:00 (C3). Since the action state is changed from a motion state to a rest state at 11:15 (B2), the processing unit 120 generates a transmission request event at B2 and transmits data between 11:00 and 11:15 (C4). In addition, the processing unit 120 periodically generates a transmission r nest event at 12:00 (A4) and transmits data between 11:15 and 12:00 (CS). In this manner, with regard to the data between 11:00 and 12:00, it is possible to suppress the mixing of the data (C4) in the motion state and the data in the rest state.

Considering the log data analysis processing, the biological information measuring apparatus 100 may collectively transmit pieces of information for specifying a user's action state corresponding to respective pieces of log data. For example, the biological information measuring apparatus 100 may transmit information for specifying C1 and C5 being rest states and C2 to C4 being motion states. As an example, information of a combination of (action state, starting timing, and termination timing) may be used, and it is possible to specify C2 to C4 being motion states by using, for example, information of (motion state, B1, and B2).

### 3.3 Scheduled Transmission Data Amount

In a case where a transmission request event occurs, log data is transmitted from the biological information measuring apparatus 100 to the connection target device 200 by using the event as a trigger. In this embodiment, described above, communication is performed using a transmission speed corresponding to a scheduled transmission data amount.

FIG. 9 illustrates an example in which the selection (computational calculation) of a transmission speed is performed in the connection target device 200. This is because it is assumed that the connection target device 200 has processing performance (performance of a processor) which is higher than that of the biological information measuring apparatus 100. However, the biological information measuring apparatus 100 can calculate a scheduled transmission data amount, and the connection target device 200 cannot directly know a scheduled transmission data amount.

Accordingly, application software of the connection target device 200 having received a transmission request event instructs GATT of the connection target device 200 to acquire a scheduled transmission data amount (S206), and GATT requests GATT of the biological information measuring apparatus 100 to transmit the scheduled transmission data amount (S207).

GATT of the biological information measuring apparatus 100 receives the request for the acquisition of the scheduled transmission data amount and notifies firmware of the reception of the request (S208). In the firmware, the scheduled transmission data amount is computationally calculated (S209). Since log data scheduled to be transmitted is stored in the storage unit 140 of the biological information measuring apparatus 100, it is possible to calculate the amount of data by the firmware.

The firmware instructs GATT of the biological information measuring apparatus 100 to transmit the calculated scheduled transmission data amount (S210), and GATT is the scheduled transmission data amount to GATT of the connection target device 200 (S211).

GATT of the connection target device 200 receives the scheduled transmission data amount and notifies the application software of the connection target device 200 of the reception of the scheduled transmission data amount (S212). The application software computationally calculates transmission speed on the basis of the received scheduled transmission data amount (S213). Specifically, the application software may computationally calculate the transmission speed on the basis of the scheduled transmission data amount and a transmission time for preventing usability to be impaired.

Here, the communication unit 130 may perform short-range wireless communication, and may set a transmission speed on the basis of a connection interval indicating an interval between connection events of the short-range wireless communication. For example, in a case where the amount of data capable of being transmitted through one communication is set to be D (Byte), a connection interval which is a communication interval is set to be CI (sec), a scheduled transmission data amount is set to be SD (Byte), and a maximum transmission time that does not impair usability is set to be T (sec), the following expression (1) is established. Since the left side in the following expression (1) represents a transmission time in a case where data scheduled to be transmitted is transmitted on the basis of the set connection interval, usability is not impaired when the following expression (1) is satisfied.

SD×(CI/D)≦T (1)

Considering power consumption, a preferable result is obtained as the connection interval becomes longer Accordingly, the processing unit (application software) of the connection target device 200 may perform a transmission speed determination process in which the maximum CI satisfying the above-mentioned expression (1) is set to be a connection interval, and more specifically may obtain the connection interval CI by the following expression (2).

CI=(T×D)/SD (2)

In this manner, it is possible to determine an appropriate transmission speed by using the connection interval which is a communication parameter of short-range wireless communication (BLE in a narrow sense). Meanwhile, one of some candidates that are set discretely may be selected as the transmission speed (connection interval). For example, a value which is equal to or less than CI obtained by the above-mentioned expression (2) and which is the maximum value is selected from the candidates of the connection interval.

Here, as described above with reference to FIG. 10, a scheduled transmission data amount changes depending on a determination result of a user's action state (hereinafter, referred to as an “action determination result”). In a case of the example illustrated in FIG. 10, sections (C2, C4, C5) which are targets for transmission by a transmission request event are determined on the basis of the timing of B1 or B2.

In addition, in a case where the amount of data per unit time fluctuates depending on an action state, the scheduled transmission data amount is determined on the basis of both the length of a section which is a target for transmission and the amount of data per unit time. Also in this case, the scheduled transmission data amount changes depending on an action determination result.

That is, in this embodiment, the processing unit 120 of the biological information measuring apparatus 100 performs a process of computationally calculating a scheduled transmission data amount on the basis of a determination result for a user's action. Here, the action determination result is information indicating a user's action state, and is information indicating any state such as a rest state or a motion state. Alternatively, each state may be further subdivided, or it may be determined what type of motion is specifically performed as a motion state. In addition, the action determination result may be a result of determination using a body motion sensor as described above, or may be a result of determination performed by a user's input on an operation unit. For example, in a case where the user operates the operation unit when motion is started and terminated, it is possible to determine whether or not the user's action state is a motion state, on the basis of the user's input.

In addition, a request for a scheduled transmission data amount received from the connection target device 200 and the transmission of the scheduled transmission data amount from the biological information measuring apparatus 100 may be performed using a packet for confirming connection. The communication unit 130 of the biological information measuring apparatus 100 transmits the scheduled transmission data amount as a response to the packet in a case where the packet (packet for confirming connection) during a connection event which is received from the connection target device 200 includes the request for the scheduled transmission data amount.

In this manner, the packet for confirming connection can be used for the request for the scheduled transmission data amount and the response thereto, and thus it is possible to transmit the scheduled transmission data amount to the connection target device 200 through efficient communication.

### 3.4 Setting of Transmission Speed

A desirable transmission speed is selected in the firmware of the connection target device 200 by the process of S213 and the previous processes. For this reason, it is possible to transmit log data at an appropriate transmission speed by performing a sequence of a change to the transmission speed between both communication units (the BLE chip of the biological information measuring apparatus 100 and the OS of the connection target device 200).

However, as an L2CAP layer is hidden from application software of a smart phone, an instruction for the change of a transmission speed may not be directly given from the application software of the connection target device 200.

Accordingly, in this embodiment, the communication unit 130 of the biological information measuring apparatus 100 is set on a slave side in short range wireless communication, and the communication unit 130 performs the setting of a transmission speed on the communication unit (OS) of the connection target device 200.

Since the processing unit 120 (firmware) of the biological information measuring apparatus 100 has a path for controlling an L2CAP layer, it is possible to acquire a desired transmission speed and to suppress a lower layer so that the transmission speed is set. That is, it is possible to set an appropriate transmission speed by causing the biological information measuring apparatus 100 side to specifically perform the control of change of a transmission speed.

That is, as illustrated in FIG. 9, in an example in which the selection of a transmission speed is performed on the connection target device 200 side, the communication unit 130 of the biological information measuring apparatus 100 receives a transmission speed change request which is information for requesting a change to a predetermined transmission speed from the connection target device 200, and the processing unit 120 may perform a process of instructing the communication unit 130 to set a transmission speed based on the transmission speed change request.

Specifically, the application software of the connection target device 200 instructs GATT of the connection target device 200 to transmit a transmission speed change request (S214), and GATT transmits the transmission speed change request to GATT of the biological information measuring apparatus 100 (S215).

GATT of the biological information measuring apparatus 100 receives the transmission speed change request and transmits the received transmission speed change request to the firmware (S216).

As described above, the firmware of the biological information measuring apparatus 100 can control L2CAP which is a layer for determining a transmission speed. Accordingly, the firmware instructs L2CAP of the biological information measuring apparatus 100 to change a transmission speed (S217). The L2CAP of the biological information measuring apparatus 100 performs transmission for updating a connection parameter to L2CAP of the connection target device 200 (S218), and L2CAP of the connection target device 200 returns a response to the transmission (S219).

In a case where the change of the transmission speed is successful, information indicating the successful change is returned as the response in S219, and thus L2CAP of the biological information measuring apparatus 100 transmits a response indicating the successful change of the transmission speed to the firmware (S220).

The firmware of the biological information measuring apparatus 100 transmits a response indicating the completion of change of the transmission speed to the connection target device 200 on the basis of the response indicating the successful change of the transmission speed which is received from L2CAP. Specifically, GATT is instructed to transmit a transmission speed change completion response (S221), and GATT of the biological information measuring apparatus 100 transmits the transmission speed change completion response to GATT of the connection target device 200 (S222). GATT of the connection target device 200 transmits the transmission speed change completion response to the application software (S223), and the application software receives the transmission speed change completion response (S224).

The sequence of S221 to S224 is performed, and thus even the application software incapable of directly controlling L2CAP can also recognize that the change of the transmission speed is successful.

The application software may perform processing such as notifying a user of the change of the transmission speed. However, even when the application software does not know the completion of change of the transmission speed, log data can be transmitted, and S221 to S224 may be omitted.

Since the change to an appropriate transmission speed is completed through the above-described sequence, log data of biological information is started to be transmitted from the biological information measuring apparatus 100 to the connection target device 200 at the transmission speed (S225).

### 4. Modification Example

Hereinafter, some modification examples will be described.

### 4.1 Setting of Slave Latency

In the above description, an embodiment in which a connection interval is used as a connection parameter for setting a transmission speed has been described. However, in short-range wireless communication (particularly, BLE), a connection parameter which is connection slave latency (connSlaveLatency) can be used together with the connection interval.

The connection slave latency is a parameter indicating the number of times of a connection event, received from a master side, is negligible in a case where there is no data transmitted from a slave side. FIG. 11 is a sequence diagram when connection interval=200 msec and connection slave latency=4. Hereinafter, the value of a connection interval will be referred to as CI, and the value of connection slave latency will be referred to as CSL.

In a case of CSL=4, even when a connection event is neglected up to four times in a case where there no data transmitted from the slave side (here, the biological information measuring apparatus 100), a connection state is maintained. For this reason, in a case where a response R1 is returned for a connection event E1 as illustrated in FIG. 11, the communication unit 130 of the biological information measuring apparatus 100 does not need to return a response for the subsequent four connection events E2 to E5. In order to prevent the connection event from being determined to be unsuccessful, the communication unit 130 may return a response R2 for a fifth connection event E6.

As seen from FIG. 11, from the viewpoint of the biological information measuring apparatus 100 which is the slave side, a response may be made at an interval of CI×(CSL+1)=1000 msec. That is, in the biological information measuring apparatus 100, the same result as in a case where communication is substantially performed at an interval of 1000 msec is obtained, and the same processing as in a case of CI=1000 msec (and CSL=0) can also be performed with respect to power consumption. In addition, with regard to the connection target device 200 which is the master side, it is necessary to perform the transmission of a packet including a connection event at an interval of 200 msec, which may result in the omission of hearing of a response received from the biological information measuring apparatus 100. In a case of the example illustrated in FIG. 11, the hearing of a response for E2 to E5 can be omitted.

As described above, approximately 1000 msec is sufficient as an interval of transmission and reception in a normal state. This can be realized when (CI, CSL)=(1000 msec, 0), but can also be realized using connection slave latency like (CI, CSL)=(200 msec, 4). That is, it is possible to suppress an increase in power consumption even when a connection interval is set to be short, by setting the connection slave latency.

In addition, in the example of FIG. 11, although a response interval of the biological information measuring apparatus 100 can be increased to a maximum of 1000 msec, a connection event itself is received at an interval of 200 msec, and thus there is also an advantage that it is possible to reduce the response interval as necessary.

Specifically, the communication unit 130 of the biological information measuring apparatus 100 sets connection slave latency of short-range wireless communication, and the communication unit 130 does not perform the neglect of a connection event based on the connection slave latency when setting a transmission speed based on a connection interval.

As illustrated in FIG. 9, when a transmission speed is set (connection interval is set), the transmission and reception of a packet between the biological information measuring apparatus 100 and the connection target device 200 are repeatedly performed a plurality of times. When (CI, CSL)=(1000 msec, 0), communication for transmitting and receiving a transmission request event, a scheduled transmission data amount, a transmission speed change request, and the like has to be performed at an interval of 1000 msec. That is, time required from the occurrence of the transmission request event to the actual start of transmission of log data is increased.

In this respect, when the relation of (CI, CSL)=(200 msec, 4) is set, it is possible to perform the communication for transmitting and receiving the transmission request event, the scheduled transmission data amount, the transmission speed change request, and the like at an interval of 200 msec and to reduce time required from the occurrence of the transmission request event to the start of transmission of log data. Meanwhile, the relation of (CI, CSL)=(200 msec, 4) is an example of values of a connection interval and connection slave latency, and specific numerical values can be modified in various ways.

Meanwhile, the change of a transmission speed in this embodiment is realized by the change of a connection interval, and it is assumed that connection slave latency is fixed. However, it is not also possible to prevent connection slave latency from being changed at the same time as when the transmission speed is changed.

### 4.2 Setting of Transmission Speed on Biological Information Measuring Apparatus Side

In the above description, a method of determining a transmission speed by the above-mentioned expression (2) and the like in the processing unit (application software) of the connection target device 200 has been described. However, this processing may be performed in the firmware of the biological information measuring apparatus 100.

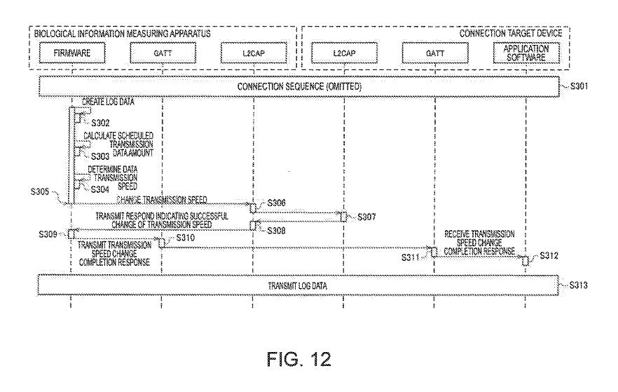

FIG. 12 is a diagram illustrating a communication sequence in this case. The biological information measuring apparatus 100 itself can obtain a scheduled transmission data amount. That is, a sequence of the return of a request for the acquisition of the scheduled transmission data amount, as a response to the reception of a transmission request event, is not necessary unlike a case where processing is performed by the connection target device 200.

As illustrated in FIG. 12, the firmware of the biological information measuring apparatus 100 creates log data of biological information on the basis of sensor information (S302), and a scheduled transmission data amount is computationally calculated when a transmission request event occurs (S303). The firmware of the biological information measuring apparatus 100 determines a transmission speed on the basis of the scheduled transmission data amount (S304). The process of S304 is the same as the process of S213 of FIG. 9, and may be performed using, for example, the above-mentioned expression (2).

Processes (S305 to S313) after the determination of the transmission speed are the same as the processes of S217 to 225 of FIG. 9, and thus a detailed description thereof will not be repeated.

In this manner, the processing unit 120 of the biological information measuring apparatus 100 may perform a process of computationally calculating a transmission speed corresponding to a scheduled transmission data amount. As seen from comparison between FIG. 9 and FIG. 12, the transmission speed is determined on the biological information measuring apparatus 100 side, and thus it is possible to simplify a sequence until the transmission of log data.

### 4.3 Setting of Transmission Speed Based on Simple Processing

In addition, the “transmission speed corresponding to scheduled transmission data amount” in this embodiment may be a transmission speed determined from the value of a scheduled transmission data amount SD which is strictly obtained as in the above-mentioned expression (2), but is not limited thereto. For example, a configuration may be adopted in which a rough value of a scheduled transmission data amount may be estimated by a simple method, and a transmission speed is determined on the basis of an estimation result.

For example, the scheduled transmission data amount may be estimated on the basis of the length of a period of time which is a target for transmission. As described above, in general, it is considered that the scheduled transmission data amount increases as a transmission target period becomes longer. Accordingly, a transmission speed determination process in which the transmission speed increases (connection interval becomes shorter) as the transmission target period becomes longer may be performed.

Alternatively, the scheduled transmission data amount may be estimated on the basis of a determination result for a user's action. As described above, a biological information acquisition rate or the amount of data of one piece of biological information may be different on the basis of the action determination result. Specifically, a change in biological information decreases as the user's movement decreases, and a problem is hardly generated in spite of low measurement frequency or low measurement accuracy. For this reason, in a case where a sleep state, a rest state, and a motion state are considered as action states, it is assumed that a scheduled transmission data amount is set like sleep state<rest state<motion state. Thus, the application software of the connection target device 200 (alternatively, the firmware of the biological information measuring apparatus 100) may determine a transmission speed on the basis of the action determination result. For example, a first transmission speed is selected in a case of the sleep state, a second transmission speed higher than the first transmission speed is selected in a case of the rest state, and a third transmission speed higher than the second transmission speed is selected in a case of the motion state.

However, since it considered that the amount of data per unit time is determined on the basis of the action determination result, the scheduled transmission data amount changes depending on the length of the transmission target period in a case where the length of the transmission target period is variable. Accordingly, the application software of the connection target device 200 (alternatively, the firmware of the biological information measuring apparatus 100) may perform a simple transmission speed determination process on the basis of both the length of the transmission target period and the action determination result.

### 4.4 Resetting of Transmission Speed

In many cases, a range of a transmission speed that can be set is determined according to the standard of proximity wireless communication. For example, in a case of BLE, a connection interval is determined to be equal to or greater than 7.5 msec and equal to or less than 4.0 sec. However, this is a value determined as the standard of BLE, and all values in the range may not be necessarily set in the real device. For example, the value of a connection interval that can be set may vary depending on the OS of the connection target device 200 (portable information processing apparatus 400), and the value of a connection interval that can be set may also vary depending on a model in spite of the same OS. The value of a connection interval that can be set can be previously obtained as long as the type, version, and model of an OS are known, but it is not easy for the application software of the connection target device 200 or the firmware of the biological information measuring apparatus 100 to ascertain all of the combinations thereof.

Accordingly, the communication unit 130 of the biological information measuring apparatus 100 performs a change to a transmission speed different from a given transmission speed in a case where a setting failure response is retuned by the communication unit (OS) of the connection target device 200 with respect to a request for a change to the given transmission speed. In this manner, even when the transmission speed is not a speed that can be set by the connection target device 200, it is possible to perform the resetting of the transmission speed.

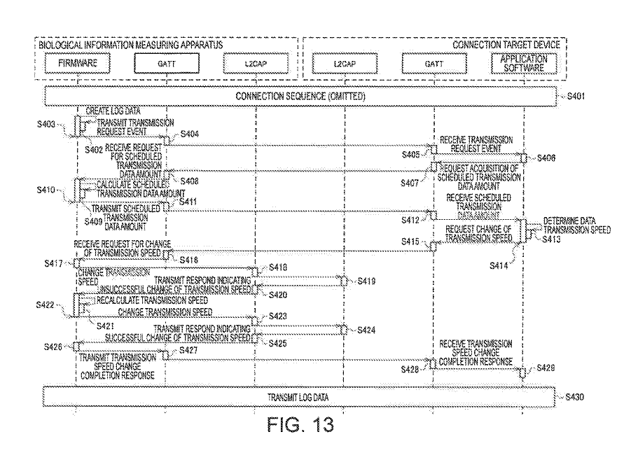

FIG. 13 is a diagram illustrating a communication sequence in a case where the resetting of a transmission speed is performed. S401 to S418 are the same as S201 to S218 of FIG. 9. In the example of FIG. 13, a transmission speed which is selected in S413 and is transmitted from L2CAP of the biological information measuring apparatus 100 by S418 is a value that cannot be set by L2CAP of the connection target device 200. Accordingly, L2CAP of the connection target device 200 returns the fact that a change to the requested transmission speed is unsuccessful, as a response to S418 (S419), and L2CAP of the biological information measuring apparatus 100 transmits a response to the effect that the change to the transmission speed is unsuccessful to the firmware (S420).

In this case, in the firmware of the biological information measuring apparatus 100, the recalculation of a transmission speed is performed (S421), and L2CAP of the biological information measuring apparatus 100 is instructed to perform a change to the transmission speed obtained by the recalculation (S422).

In the example of FIG. 13, since the transmission speed obtained in S421 has a value that can be set in the connection target device 200, S423 to S429 have the same sequence as that of S218 to S224 of FIG. 9, and the transmission of log data at the transmission speed obtained in S421 is started (S430).

Meanwhile, in a case where the recalculated transmission speed has a value that cannot be set by L2CAP of the connection target device 200, recalculation may further be performed in the firmware of the biological information measuring apparatus 100. In addition, a modification such as the setting of a limit on the number of times of recalculation can be made.

### 4.5 Transmission of Information Other Than Biological Information

In the above description, an example in which biological information is transmitted from the biological information measuring apparatus 100 to the connection target device 200 has been described, but another information may be transmitted. For example, the sensor unit 110 of the biological information measuring apparatus 100 may include a body motion sensor that detects a user's body motion or an environmental sensor that detects information regarding the peripheral environment of the user.

The processing unit 120 of the biological information measuring apparatus 100 obtains body motion information on the basis of sensor information received from the body motion sensor, and the communication unit 130 transmits the body motion information to the connection target device 200. Alternatively, the processing unit 120 of the biological information measuring apparatus 100 obtain s environmental information on the basis of sensor information received from the environmental sensor, and the communication unit 130 transmits the environmental information to the connection target device 200. Meanwhile, the environmental sensor can be realized by a temperature sensor, a humidity sensor, an atmospheric pressure sensor, a geomagnetic sensor, and the like.

The body motion information or the environmental information is used as additional information for biological information, and thus it is possible to perform the estimation of a user's activity state or the state of peripheral environment of the user when given biological information is acquired, and the like. In addition, the communication unit 130 of the biological information measuring apparatus 100 may have a period of time in which at least one of the body motion information and the environmental information is transmitted, without transmitting biological information.

### 4.6 Transmission of Information During Confirmation of Connection

In the above description, an example in which pieces of biological information are integrated into a certain degree of aggregation and are transmitted as log data has been described. However, the pieces of biological information (and body motion information or environmental information which is described as a modification example) may be sequentially transmitted.

The transmission and reception of a packet for confirming connection are performed between the biological information measuring apparatus 100 and the connection target device 200 for each predetermined interval (connection interval). In the packet for confirming connection, data indicating a connection event is included in a payload portion in a given layer (LL of FIG. 8), but an empty region is present in a payload portion in another layer.

The communication unit 130 of the biological information measuring apparatus 100 may include pieces of biological information in this empty region to thereby sequentially transmit the nieces of biological information. For example, the amount of data of information indicating a difference (the amount of change) from biological information at the previous timing is small, and thus it is possible to transmit the information to the connection target device 200 by using the empty region.

### 4.7 Sequence When Transmission of Log Data is Completed

In addition, a sequence until the start of transmission of log data has been described in FIG. 9 and the like, but the change of a transmission speed may be performed even after the transmission of the log data is completed. Since it is assumed that the amount of log data is comparatively large, it is considered that a transmission speed used for the transmission is higher than a transmission speed in a normal occasion in many cases. As an example, a case is considered in which a connection interval is 200 msec in a normal occasion, while a connection interval of 35 to 50 msec is used during the transmission of log data.

In this case, power consumption increases during the transmission of log data as compared to a normal state, which results in a great disadvantage due to communication being continued at high speed until the transmission of the log data is completed. Accordingly, the transmission speed may be set to be relatively low when the transmission of the log data is completed, and may be returned to, for example, a transmission speed in a normal occasion.

Since information to that effect is stored in a final packet of the log data, it is possible to ascertain the completion of transmission of the log data in either the firmware of the biological information measuring apparatus 100 or the application software of the connection target device 200. Accordingly, a sequence for returning the transmission speed to a transmission speed in a normal occasion may be performed with either of them as a starting point.

In a case where the application software of the connection target device 200 is set to be a starting point, first, it is necessary to transmit a request for the change of a transmission speed to the biological information measuring apparatus 100, similar to S214 of FIG. 9. On the other hand, in a case where the firmware of the biological information measuring apparatus 100 is set to be a starting point, the firmware itself may instruct L2CAP to change the transmission speed.

### 4.8 Another Example of Connection Target Device

In the above description, an example in which the connection target device 200 is the portable information processing apparatus 400 (smart phone in a narrow sense) has been described. However, the connection target device 200 is not limited thereto, and may be the gateway device 600.

As described above with reference to FIG. 5, in a case where the biological information measuring apparatus 100 is connected to the portable information processing apparatus 400, it is considered that the portable information processing apparatus 400 can be connected to a computer communication network INT. Here, the computer communication network INT is, for example, the Internet which is a network based on a communication standard of TCP/IP. For example, the computer communication network INT is a network through which a computer on the network can be individually identified by a unique IP address. For example, the computer communication network INT is a wide-area network (WAN) allowing communication connection of a server. The computer communication network INT may include a communication network such as a cable network, a telephone communication network, or a wireless LAN, and a wired or wireless communication method may be used.

For this reason, also in the example of FIG. 5, it is possible to perform Internet connection such as the uploading of information of the wearable device 300 to the Internet (INT) or the downloading of information of the Internet to the wearable device 300. However, the portable information processing apparatus 400 is necessary for the connection of the wearable device 300 to the Internet, and the wearable device 300 cannot be singly connected to the Internet. In general, the power consumption of the portable information processing apparatus 400 is larger than that of the wearable device 300, which may result in the exhaustion of charged power. In this case, the portable information processing apparatus cannot be connected to the Internet. For this reason, it may be difficult to maintain the connection of the wearable device 300 to the Internet at all times.

Consequently, in this embodiment, the gateway device 600 that can be connected to a large number of unspecified devices through short-range wireless communication and can be connected to the computer communication network INT may be used as the connection target device 200.

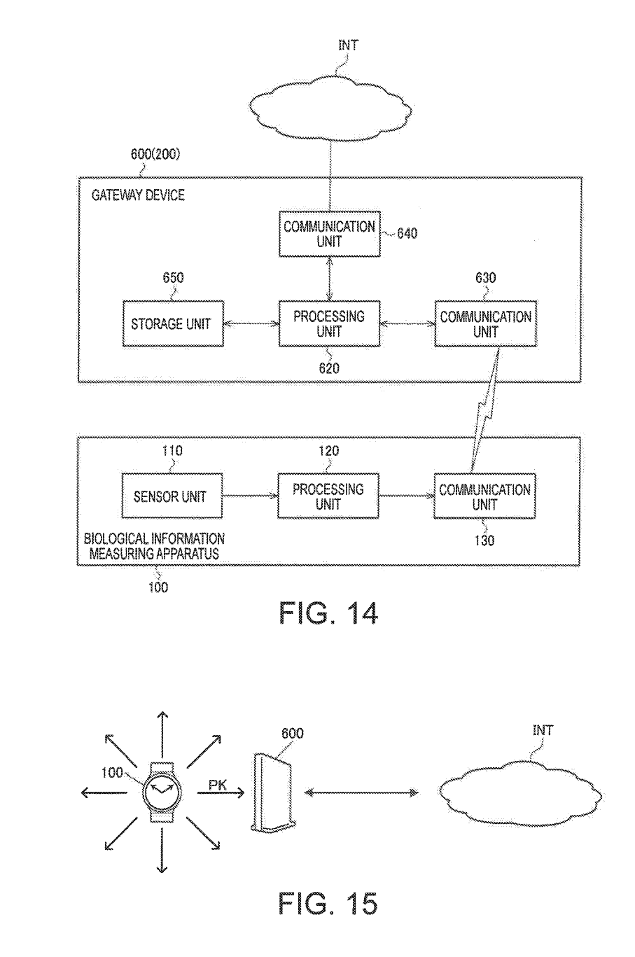

FIG. 14 illustrates configuration examples of the biological information measuring apparatus 100 and the gateway device 600 according to this embodiment. The biological information measuring apparatus 100 has the same configuration as that illustrated in FIG. 2, and thus a description thereof will not be repeated. The gateway device 600 includes a processing unit 620, communication units 630 and 640, and a storage unit 650. Meanwhile, a configuration of the gateway device 600 is not limited to the configuration illustrated in FIG. 14, various modifications such as the omission of a portion of the components thereof, the addition of other components, or the change of a connection relation can be made.

The processing unit 620 (processor) processes various pieces of information or performs control. Each processing (each function) performed by the processing unit 620 can be realized by a processor (processor including hardware).

The communication unit 630 is a circuit (IC) that performs short-range wireless communication, similar to the communication unit 130 of the biological information measuring apparatus 100.

The communication unit 640 performs communication processing using the computer communication network INT such as the Internet. The communication unit 640 can be realized by hardware, such as a communication ASIC or a communication processor, firmware for communication, or the like. For example, the communication unit 640 performs communication processing according to the specifications of Ethernet (registered trademark; the same applies hereinafter) as processing of a physical layer or a data link layer. In addition, the communication unit performs communication processing according to the specifications of TCP/IP as processing of a network layer or a transport layer. In this case, the processing unit 620 of the gateway device 600 performs protocol conversion between, for example, a protocol (for exam Bluetooth) of short-range wireless communication and a protocol (for example, Ethernet or TCP/IP) of the computer communication network INT. For example, the processing unit performs processing such as reconstitution of a packet of the protocol of the short-range wireless communication into a packet of the protocol of the computer communication network INT or reconstitution of the packet of the protocol of the computer communication network INT into the packet of the protocol of the short-range wireless communication. For example, the processing unit performs processing such as conversion of address information (for example, a MAC address of Bluetooth) of the wearable device 300 into address information (for example, IPv6 of TCP/IP) for the computer communication network INT, and the like.

The storage unit 650 (memory) stores various pieces of information, and functions as a work area for the processing unit 620 or the communication units 630 and 640, and the like.

In this codification example, it is possible to adopt a method of directly connect the biological information measuring apparatus 100 to the computer communication network INT such as the Internet by loosely-coupled short-range wireless communication. The biological information measuring apparatus 100 (communication unit 130) is communicatively connected to the gateway device 600 by loosely-coupled short-range wireless communication, and is communicatively connected to the computer communication network INT through the gateway device 600. That is, the biological information measuring apparatus 100 and the gateway device 600 (for example, a router such as Bluetooth) are communicatively connected to each other by loosely-coupled short-range wireless communication. For example, the communication unit 130 of the biological information measuring apparatus 100 of FIG. 14 and the communication unit 630 of the gateway device 600 transmit and receive information to and from each other by loosely-coupled short-range wireless communication. Taking Bluetooth as an example, the transmission and reception of information are performed by loosely-coupled short-range wireless communication before the establishment of on to-one communication connection based on pairing. The communication unit 640 of the gateway device 600 performs communication based on, for example, the Internet protocol (Ethernet, TCP/IP), and thus the gateway device 600 and the computer communication network INT (for example, server) are communicatively connected to each other. Thereby, the biological information measuring apparatus 100 and the computer communication network INT are directly communicatively connected to each other through the gateway device 600 by a short-range wireless communication network.

Here, the loosely-coupled short-range wireless communication is wireless communication in which the degree of coupling of communication is lower than that of normally-coupled short-range wireless communication. For example, in the normally-coupled short-range wireless communication, processing (for example, pairing) for establishing communication connection between two devices paired for bidirectional communication is performed. When the communication connection is once established, a predetermined cancellation process for the cancellation thereof is necessary. In the normally-coupled short-range wireless communication, a protocol and the like are defined as wireless communication in a normal mode (default) in communication standards (Bluetooth and the like) of the short-range wireless communication network.

On the other hand, the loosely-coupled short-range wireless communication is wireless communication in which, for example, bidirectional communication is performed between two devices with a low degree of coupling of communication, without performing such processing for establishing communication connection. In the loosely-coupled short-range wireless communication, the establishment of communication connection specified by the above-described normally-coupled short-range wireless communication is not performed, and thus a cancellation process for the cancellation thereof is not necessary. For this reason, a device such as the biological information measuring apparatus 100 can be communicatively connected to the computer communication network INT through a connection target device such as the gateway device 600 while continuously switching the connection target device. An example of the loosely-coupled short-range wireless communication is communication performed in a preparation period before the establishment of communication connection, and an example of the preparation period is a scanning period in which a presence notification packet is retrieved. That is, the loosely-coupled short-range wireless communication is, for example, communication performed in a scanning period (retrieval period) in which the gateway device 600 retrieves the presence notification packet received from the biological information measuring apparatus 100.

For example, in FIG. 15, the biological information measuring apparatus 100 performs a process of transmitting a presence notification packet PK for notifying the surrounding of its presence, for example, for each given period. The transmission of the presence notification packet PK is performed by the communication unit 130 of FIG. 14. On the other hand, the gateway device 600 performs a scanning operation of finding the biological information measuring apparatus 100 present in the vicinity thereof by capturing the presence notification packet PK. The loosely-coupled short-range wireless communication is communication performed in the scanning period.

Since the loosely-coupled short-range wireless communication is communication performed in the scanning period before the establishment of connection, processing for the cancellation of establishment of connection or a user's effort is not necessary. Therefore, it is possible to achieve a reduction in power consumption of a wearable device, an improvement in user convenience, and the like. Since the transmission of a presence notification packet is intermittent transmission, there is also an advantage that it is possible to achieve a further reduction in power consumption, for example, by appropriately controlling a transmission interval of the presence notification packet.

Meanwhile, in this modification example, the gateway device 600 includes the processing unit 620 performing protocol conversion and like, as illustrated in FIG. 14. Accordingly, it is not possible to prevent a process of determining a transmission speed corresponding to a scheduled transmission data amount from being performed by the gateway device 600. However, it is also considered that the processing unit 620 of the gateway device 600 does not assume the execution of various processes. In this case, as illustrated in FIG. 12, it is preferable that the transmission speed determination process is performed on the biological information measuring apparatus 100 side.

As described above, the embodiment and the modification example to which the invention is applied have been described. However, the invention is not limited to the embodiment and the modification example as they are, and components can be modified and embodied without departing from the scope of the invention at the stage of implementing the invention. In addition, various inventions can be formed by an appropriate combination of a plurality of components disclosed in the above-described embodiment and modification example. For example, some components may be deleted from all of the components described ire the embodiment and the modification example. Furthermore, components described in different embodiments and modification examples may be appropriately combined with each other. In addition, throughout the specification and the drawings, any terms described at least once together with other different terms that encompass broader meaning or are synonymous can be replaced with these different terms in any sections of the specification and the drawings. In this manner, various modifications or application can be made without departing from the scope of the invention.

What is claimed is:

1. A biological information measuring apparatus comprising
a sensor unit;
a processing unit that detects biological information on the basis of sensor information received from the sensor unit; and
a communication unit that transmits the biological information to a connection target device at a transmission speed corresponding to a scheduled transmission data amount of the biological information.

2. The biological information measuring apparatus according to claim 1,
wherein the communication unit receives a transmission speed change request, which is information for requesting a change to a predetermined transmission speed, from the connection target device, and
wherein the processing unit performs a process of instructing the communication unit to set the transmission speed based on the transmission speed change request.

3. The biological information measuring apparatus according to claim 2,
wherein the communication unit
transmits scheduled transmission data amount information indicating the scheduled transmission data amount of the biological information to the connection target device,
receives the transmission speed change request indicating the transmission speed determined on the basis of the scheduled transmission data amount information from the connection target device, and
transmits the biological information to the connection target device at the transmission speed based on the received transmission speed change request.

4. The biological information measuring apparatus according to claim 1,
wherein the communication unit
transmits the biological information to the connection target device at a first transmission speed in a case where the scheduled transmission data amount of the biological information is a first data amount, and
transmits the biological information to the connection target device at a second transmission speed higher than the first transmission speed in a case where the scheduled transmission data amount of the biological information is a second data amount larger than the first data amount.

5. The biological information measuring apparatus according to claim 1,
wherein the processing unit performs a process of computationally calculating the scheduled transmission data amount or a process of computationally calculating the transmission speed corresponding to the scheduled transmission data amount, on the basis of a determination result for a user's action.

6. The biological information measuring apparatus according to claim 1, further comprising:
a storage unit that stores log data of the biological information,
wherein the communication unit transmits a transmission request event for the log data to the connection target device.

7. The biological information measuring apparatus according to claim 6,
wherein the communication unit transmits the transmission request event to the connection target device in a case where elapse of a predetermined time or a change in the user's action state is detected.

8. The biological information measuring apparatus according to claim 1,
wherein the communication unit performs short-range wireless communication and sets the transmission speed on the basis of a connection interval indicating an interval between connection events of the short-range wireless communication.

9. The biological information measuring apparatus according to claim 8,
wherein the communication unit sets connection slave latency of the short-range wireless communication, and
wherein the communication unit does not perform neglect of the connection event based on the connection slave latency when the transmission speed based on the connection interval is set.

10. The biological information measuring apparatus according to claim 8,
wherein the communication unit transmits the scheduled transmission data amount as a response to a packet during the connection event which is received from the connection target device, in a case where a request for the scheduled transmission data amount is included in the packet.

11. The biological information measuring apparatus according to claim 8,
wherein the communication unit is set on a slave side in the short-range wireless communication, and
wherein the communication unit performs setting of the transmission speed on a communication unit of the connection target device.

12. The biological information measuring apparatus according to claim 11,
wherein the communication unit performs a change to a transmission speed different from a given transmission speed in a case where a setting failure response is returned by the communication unit of the connection target device, with respect to a request for a change to the given transmission speed.

13. The biological information measuring apparatus according to claim 1,
wherein the connection target device is a portable information processing apparatus or a gateway device.

14. A communication system comprising:
a biological information measuring apparatus including a sensor unit, a first processing unit that detects biological information on the basis of sensor information received from the sensor unit, and a first communication unit that transmits scheduled transmission data amount information indicating a scheduled transmission data amount of the biological information; and
a connection target device including a second communication unit that receives the scheduled transmission data amount information, and a second processing unit that determines a data transmission speed between the first communication unit and the second communication unit on the basis of the scheduled transmission data amount information,
wherein the second communication unit transmits the data transmission speed determined by the second processing unit to the biological information measuring apparatus, and the biological information measuring apparatus transmits the biological information to the connection target device at the data transmission speed.

15. A communication method comprising:
detecting biological information on the basis of sensor information received from a sensor unit; and
transmitting the biological information to a connection target device at a transmission speed corresponding to a scheduled transmission data amount of the biological information.

16. The communication method according to claim 15,
wherein the transmitting of the biological information includes
transmitting the biological information to the connection target device at a first transmission speed in a case where the scheduled transmission data amount of the biological information is a first data amount, and
transmitting the biological information to the connection target device at a second transmission speed higher than the first transmission speed in a case where the scheduled transmission data amount of the biological information is a second data amount larger than the first data amount.

17. The communication method according to claim 15,
wherein the transmitting of the biological information includes determining the scheduled transmission data amount or determining the transmission speed corresponding to the scheduled transmission data amount, on the basis of an action determination result of an action performed by a user.

18. The communication method according to claim 15,
wherein the transmitting of the biological information includes setting the transmission speed on the basis of a connection interval indicating an interval between connection events in short-range wireless communication.

19. The communication method according to claim 15, further comprising:
storing log data of the biological information,
wherein the transmitting of the biological information includes transmitting a transmission request event for the log data to the connection target device.

20. The communication method according to claim 19,
wherein the transmitting of the biological information includes transmitting the transmission request event to the connection target device in a case where elapse of a predetermined time or a change in the user's action state is detected.
